(19) United States
(12) Patent Application Publication
(10) Pub. No.: US 2023/0278416 A1
(43) Pub. Date: Sep. 7, 2023

(54) HEAT EXCHANGER WITH A MOUNTING PORTION

(71) Applicant: Valeo North America, Inc., Troy, MI (US)

(72) Inventor: Raul WALLS, Troy, MI (US)

(73) Assignee: Valeo North America, Inc., Troy, MI (US)

(21) Appl. No.: 17/685,939

(22) Filed: Mar. 3, 2022

(51) Int. Cl. B60K 11/04; F28F 9/007

(52) U.S. Cl. CPC B60K 11/04; F28F 9/007; F28F 2275/143

(57) ABSTRACT

A heat exchanger including a mounting portion for fixing to further structures. The mounting portion has an elastic element with a core and a plurality of contact arms attached to the core and protruding away from the core in the same protrusion plane. Protrusion path of each contact arm is at least partially curved.

### TECHNICAL FIELD

The invention relates to heat exchangers, in particular heat exchangers adapted for mounting in vehicles.

### BACKGROUND OF THE INVENTION

Vehicles utilize all sorts of heat exchangers, such as for example radiators, condensers, battery coolers, charge air coolers, chillers etc. Their function can be to either heat or cool various fluids participating to vehicle's operation and/or passenger comfort. In one example, the heat exchanger can be used to transfer heat to or from vehicle component, such as an electrical storage device.

Any component of a moving vehicle is subject to forces resulting from its acceleration and deceleration. Similarly, because vehicles travel on various surfaces—some are dedicated for utilization on smooth and well-maintained roads, other are envisioned for rougher conditions—these components are subject to resulting vibrations. Vibrations can also be imparted to components because other components of the vehicle can actively generate them, as is in the case of internal combustion engines. In general, such vibrations are detrimental to any component or subsystem, as it can damage the structure and prohibit proper operation. For heat exchangers this can for example lead to leaking of the heat exchange fluids, not only contributing negatively to heat exchange effectiveness, but also to increased risk of damage to other components and systems, even creating a serious risk for the passengers and other members of the traffic.

At least for these reasons, any component must be securely attached within the vehicle. This connection should also ensure some sort of dampening to mitigate or eliminate risk of component damage or detachment. At the same time, it is important to minimize cost of manufacturing and weight of any such assembly between components and their desired mounting destination.

Consequently, it would be desirable to provide a heat exchanger with mounting means, which would provide vibration dampening and be cost effective, without unnecessarily contributing to the vehicle's overall weight.

### BRIEF SUMMARY OF THE INVENTION

In one aspect, a heat exchanger comprising a mounting portion for fixing to further structures is described. The mounting portion includes an elastic element comprising a core and a plurality of contact arms attached to the core and protruding away from the core in the same protrusion plane, wherein a protrusion path of each contact arm is at least partially curved.

In some embodiments, the core is of tubular shape, the contact arms protruding from its side wall.

In some embodiments, the elastic element is molded into the mounting portion.

In some embodiments, the elastic element is mechanically attached to the mounting portion.

In some embodiments, the mounting portion comprises a protrusion on which the core is mounted.

In some embodiments, all contact arms follow identical protrusion paths within the protrusion plane.

In some embodiments, the circumference of the core is constituted by a first part of the side wall and a substantially opposite second part of the side wall, wherein the contact arms protrude only from the first part.

In some embodiments, the first part of the side wall constitutes 30-70% of the circumference of the core.

In some embodiments, the first part of the side wall constitutes 40-60% of the circumference of the core.

In some embodiments, the elastic element comprises a lock-in-place arrangement.

In some embodiments, the cross-section of the core has a circular outline.

In some embodiments, the cross-section of the core has an oval outline.

In some embodiments, the elastic element has a substantially a squared outline in the protrusion plane.

In some embodiments, the ends of the contact arms are rounded.

In some embodiments, the heat exchanger comprises a plastic tank, the plastic tank comprising the mounting portion.

Another aspect is a vehicle structure comprising a mounting slot, further having a heat exchanger having a mounting portion for fixing the heat exchanger to further structures, wherein the mounting portion includes an elastic element having a core and a plurality of contact arms, with the plurality of contact arms attached to the core and protruding away from the core in the same protrusion plane, wherein a protrusion path of each contact arm is at least partially curved, wherein the elastic element is mounted in the mounting slot.

### BRIEF DESCRIPTION OF THE DRAWINGS

The present invention will be described in greater detail below with reference to the drawings. In the drawings:

FIG. 1 shows a heat exchanger according to the invention;

FIG. 2 shows an embodiment of an elastic element according to the invention;

FIG. 3 shows another embodiment of an elastic element according to the invention;

FIG. 4 shows another embodiment of an elastic element according to the invention;

FIG. 5 shows another embodiment of an elastic element according to the invention;

FIG. 6 shows another embodiment of an elastic element according to the invention; and

FIG. 7 shows an embodiment of a contact arm of the elastic element.

### DETAILED DESCRIPTION OF THE INVENTION

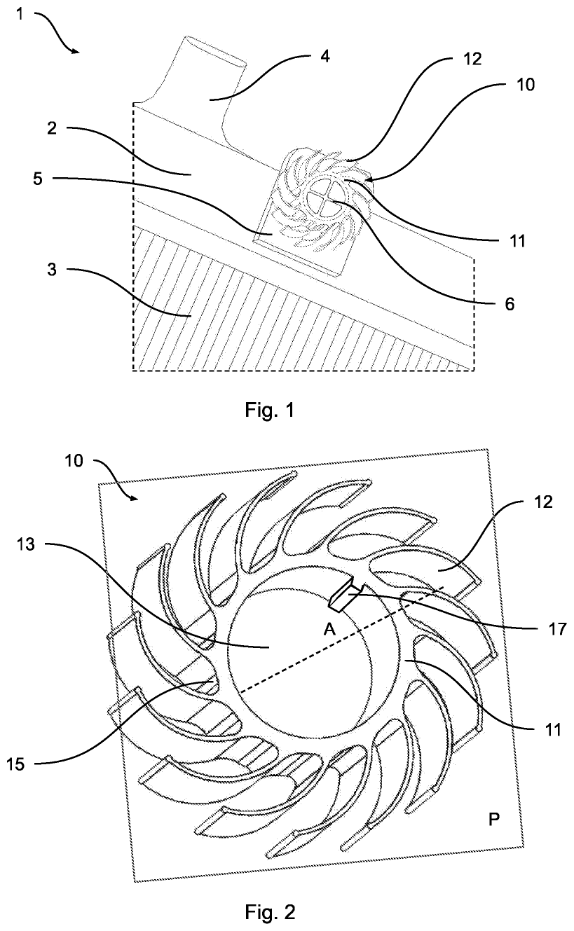

FIG. 1 shows a heat exchanger 1 according to the invention. The heat exchanger 1 can be a part of a heat exchange circuit, for example an air conditioning circuit utilizing a refrigerant as a heat exchange fluid. Another example can be a heat exchange circuit for heating or cooling a battery of an electric vehicle.

In one embodiment, the heat exchanger 1 comprises a plurality of tubes 3 terminating in at least one tank 2, preferably a plastic one, preferably in two tanks 2 so that a heat exchange fluid can travel therebetween. In this embodiment, the tubes 3 are spaced so that another fluid, preferably air, can traverse the space and exchange heat with the heat exchange fluid. In the shown embodiment, the tank 2 has a connecting nozzle 4 working as an inlet or outlet for the heat exchange fluid.

The heat exchanger 1 comprises a mounting portion 5. In one embodiment, the mounting portion 5 is located at the tank 2. The mounting portion 5 serves for fixing the heat exchanger 1 to further structures. Further structures can be for example a heat exchange module, a cooling module, a structural element of a vehicle—all of those can be alternatively referenced as a “vehicle structure”.

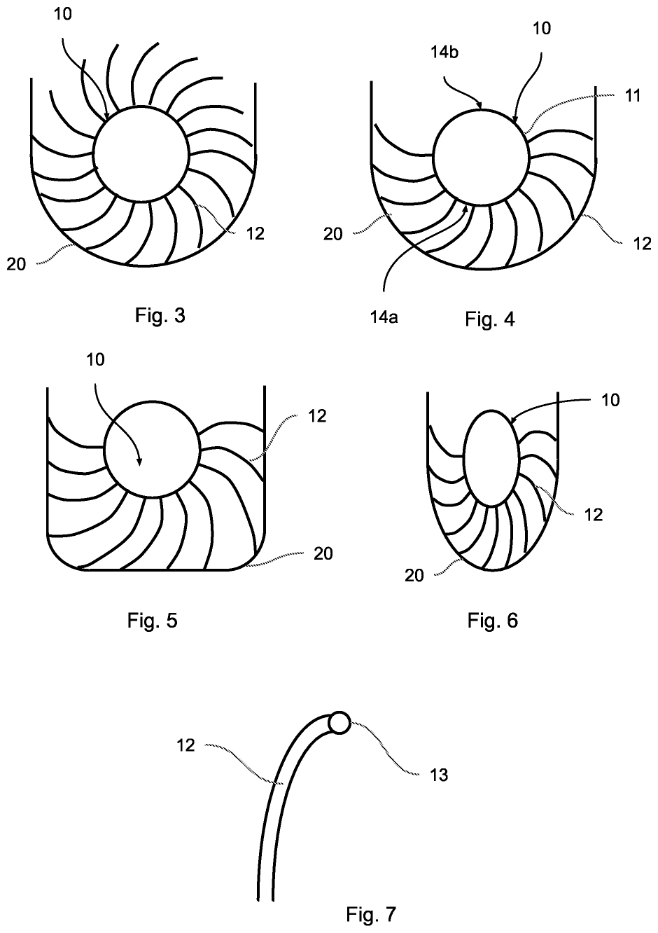

The mounting portion 5 comprises an elastic element 10. The elastic element 10 comprises a core 11 and a plurality of contact arms 12 attached to the core 11. The elastic element 10 is envisaged to be received in a slot of a further structure onto which the heat exchanger 1 is to be mounted, as is illustratively presented in FIGS. 3 to 6.

In some embodiments, the elastic element 10 can be molded into the mounting portion 5. In other words, the elastic element 10 can be integrally encapsulated within the material constituting the mounting portion 5 in a fixed manner. In some embodiments, it can be impossible to remove the elastic element 10 from the mounting portion 5 without damaging the mounting portion 5. In one embodiment the mounting portion 5 being a plastic element, the elastic element 10 is inserted during the molding of the mounting portion 5 so that after the molding process is finished and the mounting portion 5 is cooled and solidified, the elastic element 10 is fixed with respect to the heat exchanger 1.

Alternatively, the elastic element 10 can be mechanically attached to the mounting portion 5. In other words, the elastic element 10 can be attached to a mounting portion 5 after the mounting portion 5 is manufactured in a separate process. An example of such mechanical attachment is utilization of further fixing means like adhesives. Another example can be a shape connection. Another example can be a threaded connection between the mounting portion 5 and the elastic element 10. Another example can be utilization of further fixing elements, such as screws or clamps.

In some embodiments, the mounting portion 5 comprises a protrusion 6 on which the core 11 is mounted. In such case, the core 11 can have an opening 13 in which the protrusion 6 is received. In one embodiment, the opening 13 is a through-hole. It can also be a cavity. The connection between the protrusion 6 and the core 11 can be of detachable or non-detachable type.

FIG. 2 shows an embodiment of an elastic element 10 in detail. The elastic element 10 can be made of metal. The elastic element 10 can be made of plastic. The contact arms 12 protrude away from the core 10. The contact arms 12 protrude at least in the same protrusion plane P. In other words, the contact arms 12 are all extending at least within one common protrusion plane P. The contact arms 12 have a length and a shape which enables them to elastically deform when the force is imparted onto the heat exchanger 1 while it is mounted in a further structure by means of the elastic element 10. Thus, any vibration or movement of the heat exchanger 1 can be damped with respect to the further structure. In the shown embodiment, the core 11 is of tubular shape defined at least by a side wall 15 having a tubular shape extending along an extension axis A. The contact arms 12 protrude from its side wall 15 away from the extension axis A. In other words, the mounting portion 5 comprises an elastic element 10 comprising a plurality of radially protruding contact arms 12. All contact arms 12 are identical, which means their protrusion paths and lengths are identical. The contact arms 12 are curved to one side, in particular to the right hand side. They can however be also all curved to the left hand side. In any case, since all the contact arms 2 are distributed evenly along the circumference of the tubular core 11, and protrude away from the tubular core 11 and away from the extension axis A being located in the symmetrical center of the tubular core 11, the contact arms 2 of the elastic element 10 have a spiral configuration. The protrusion plane P is perpendicular with respect to the extension axis A. The contact arms 12 have a width measured parallel to the extension axis A of the core 11. The width of the contact arms 12 can be adjusted to the dampening requirements for the heat exchanger 1.

In some embodiments, within the protrusion plane P, the protrusion paths of some contact arms 12 are at least partially curved. In some embodiments, within the protrusion plane P, the protrusion path of each contact arm 12 is at least partially curved. In one embodiment, the whole protrusion path of some or each contact arm 12 is curved. The curvature of a contact arm 12 enables it to elastically deform and absorb vibrations of the further structure, e.g. of a vehicle, which might otherwise strain a connection with the heat exchanger 1 or the heat exchanger 1 itself.

Illustratively, all arms 12 follow identical protrusion paths within the protrusion plane P. In such case, the elastic element 10 does not need to be specifically oriented with respect to extension axis A and/or the desired mounting slot.

Alternatively, a part of the contact arms 12 follow identical protrusion path, while other part or parts of the contact arms 12 follow a different protrusion path or paths. The protrusion paths can be adjusted to accommodate specific dampening requirements of the mounting assembly.

In some embodiments, the elastic element 10 comprises a lock-in-place arrangement. Illustratively, the elastic element 10 and/or the mounting portion 5 are configured so that the elastic element 10 can be attached to the mounting portion 5 in only one possible position and orientation. In such manner, any mounting and positioning error during assembly process can be prevented. In one embodiment, the lock-in-place arrangement can comprise a flexing retaining element which flexes during mounting of the elastic element 10 onto the mounting portion 5 and then snaps back to provide fixing engagement between the components. In FIG. 2, a key 17 is shown. The protrusion comprises a groove (not shown) to receive the key 17 and together provide the lock-in-place arrangement. In another embodiment, the key can be included on the protrusion 6 and the groove can be located on the elastic element 10.

FIGS. 3-6 are illustrative of elastic elements in accordance with multiple embodiments. In some embodiments, the cross-section of the core 10 has a circular outline. FIG. 3 illustrates an elastic element 10 placed in a mounting slot 20 of a further structure. The shape of the mounting slot 20 corresponds to the shape of the elastic element 10. The heat exchanger 1 can thus be easily and securely mounted to a further structure.

FIG. 4 shows another embodiment of an elastic element 10. In this embodiment, the circumference of the core 11 is constituted by a first part 14a of the sidewall 15 and a substantially opposite second part 14b of the side wall 15. The contact arms 12 protrude only from the first part 14a. In one embodiment, the first part 14a of the sidewall 15 constitutes 30-70% of the circumference of the core 10. In one embodiment, the first part 14a of the sidewall 15 constitutes 40-60% of the circumference of the core 10.

FIG. 5 shows another embodiment of an elastic element 10 according to the invention. In some embodiments, the contact arms 12 can be different lengths so that the elastic element 10 can have a substantially a squared outline in the protrusion plane P. This permits the elastic element 10 to be mounted in a square shaped slot 20 of a further structure.

FIG. 6 shows another embodiment of an elastic element 10 according to the invention. In some embodiments, the cross-section of the core 10 can have an oval outline. This can be beneficial in view of space constraints.

FIG. 7 shows another embodiment of a contact arm 12 of the elastic element 10. In some embodiments, the ends of contact arms 12 are rounded. In other word, the ends of the contact arms 12 can have a ball-shaped portion 13. This can facilitate movement of the contact arms 12 in the mounting slot 20 resulting from the vehicle's movement and/or vibrations.

In summary, the invention provides a low cost design, which enables to attach a heat exchanger to further structures in a simplified and secure manner. It is possible to ensure error proofing by the design, as the elastic element can be molded into the mounting portion of the tank during its manufacturing. The elastic element thus is prevented from detaching from the heat exchanger during handling.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

1. A heat exchanger comprising a mounting portion for fixing the heat exchanger to further structures, wherein the mounting portion includes an elastic element having a core and a plurality of contact arms, with the plurality of contact arms attached to the core and protruding away from the core in the same protrusion plane, wherein a protrusion path of each contact arm is at least partially curved.

2. The heat exchanger of claim 1, wherein the core is of tubular shape, with the contact arms protruding from a sidewall of the core.

3. The heat exchanger of claim 2, wherein the circumference of the core is constituted by a first part of the side wall and a substantially opposite second part of the side wall, wherein the contact arms protrude only from the first part.

4. The heat exchanger of claim 3, wherein the first part of the sidewall constitutes 30-70% of the circumference of the core.

5. The heat exchanger of claim 3, wherein the first part of the sidewall constitutes 40-60% of the circumference of the core.

6. The heat exchanger of claim 1, wherein the elastic element is molded into the mounting portion.

7. The heat exchanger of claim 1, wherein the elastic element is mechanically attached to the mounting portion.

8. The heat exchanger of claim 4, wherein the mounting portion comprises a protrusion on which the core is mounted.

9. The heat exchanger of claim 1, wherein the plurality of contact arms follow identical protrusion paths within the protrusion plane.

10. The heat exchanger of claim 1, wherein the elastic element comprises a lock-in-place arrangement.

11. The heat exchanger of claim 1, wherein a cross-section of the core has a circular outline.

12. The heat exchanger of claim 1, wherein a cross-section of the core has an oval outline.

13. The heat exchanger of claim 1, wherein the elastic element has a substantially a squared outline in the protrusion plane.

14. The heat exchanger of claim 1, wherein the ends of the contact arms are rounded.

15. The heat exchanger of claim 1, further comprising a plastic tank, with the mounting portion being affixed to the plastic tank.

16. A vehicle structure comprising a mounting slot, further having a heat exchanger having a mounting portion for fixing the heat exchanger to the vehicle structure, wherein the mounting portion includes an elastic element having a core and a plurality of contact arms, with the plurality of contact arms attached to the core and protruding away from the core in the same protrusion plane, wherein a protrusion path of each contact arm is at least partially curved, wherein the elastic element is mounted in the mounting slot.
